(19) United States
(12) Patent Application Publication
(10) Pub. No.: US 2009/0163652 A1
(43) Pub. Date: Jun. 25, 2009

(54) THERMOSETTING RESIN COMPOSITION AND USE THEREOF

(75) Inventors: Akio Tajima, Chiba (JP); Terumasa Kondo, Chiba (JP); Kazuhiro Yoshida, Chiba (JP)

Correspondence Address: J C PATENTS, INC., 4 VENTURE, SUITE 250, IRVINE, CA, 92618, US

(73) Assignee: CHISSO CORPORATION, Osaka (JP)

(21) Appl. No.: 12/338,658

(22) Filed: Dec. 18, 2008

(30) Foreign Application Priority Data
Dec. 19, 2007 (JP) 2007-327113
Nov. 20, 2008 (JP) 2008-297132

(51) Int. Cl. C08K 11/00; C08L 63/00

(52) U.S. Cl. 524/612; 525/524

(57) ABSTRACT

A thermosetting resin composition containing a silsesquioxane derivative represented by the formula (1), cyclohexane-1,3,4-tricarboxylic 3,4-anhydride, and another acid anhydride, a cured material obtained by thermally curing the composition:

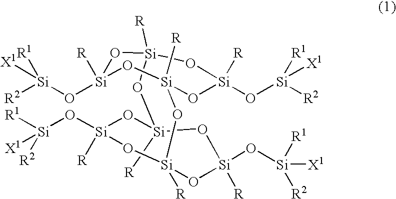

The meanings of the symbols in the formula (1) are shown in the description.

### CROSS-REFERENCE TO RELATED APPLICATION

This application claims the priority benefit of Japanese applications serial no. 2007-327113, filed on Dec. 19, 2007 and serial no. 2008-297132, filed on Nov. 20, 2008. The entirety of the above-mentioned patent applications is hereby incorporated by reference herein and made a part of specification.

### BACKGROUND OF THE INVENTION

1. Field of the Invention

The present invention relates to a thermosetting resin composition that is useful for such purposes as a coating material, an optical material and an electric insulating material, and a cured material obtained by thermally curing the composition.

2. Description of the Related Art

A light emitting device, such as a light emitting diode (LED), which is practically used in recent years as a display panel, a light source for reading images, a traffic signal, a large-scale display unit and a backlight for a mobile phone, is generally produced by sealing with a resin composition containing an aromatic epoxy resin with an alicyclic acid anhydride as a curing agent. However, it is known that the resin composition suffers discoloration of the acid anhydride due to acid and requires a prolonged period of time for curing. Furthermore, the cured sealing resin has a problem of yellowing in the case where the cured resin is left outdoors or is exposed to a light source emitting an ultraviolet ray.

For solving the problems, such an attempt has been made that an alicyclic epoxy resin or an acrylic resin is used, and an LED or the like is sealed therewith by using a cationic polymerization initiator (see Patent Documents 1 and 2). However, the cured resin obtained by cationic polymerization has such severe problems that the cured resin is liable to suffer breakage due to cracks under cold heat cycle due to the significant brittleness thereof, and suffers considerable coloration after curing as compared with the conventional aromatic epoxy resin-acid anhydride curing system. Accordingly, the cured resin is not suitable for a purpose that requires colorless and transparent nature, particularly a resin for sealing an LED, which particularly requires heat resistance and transparency.

Patent Document 3 discloses a resin composition for sealing an LED that is improved in resistance to cracking under cold heat cycle and is excellent in light stability. The resin composition shown in Patent Document 3 contains a hydrogenated epoxy resin or an alicyclic epoxy resin as a matrix component, but still has room for improvement in discoloration since it suffers significant coloration after curing.

Patent Document 4 discloses an embedding resin composition containing an alicyclic epoxy resin or an oxetane resin as a viscosity reducing agent, which is used for filling a gap between an electronic part and a board in a circuit board. However, the resin composition contains a large amount of an inorganic filler, and thus cannot be applied to a filed that requires transparency. Patent Document 5 discloses a resin composition containing a modified oxetane resin as an active energy radiation-curable resin and being soluble in an alkali aqueous solution. The object of the resin composition is to be soluble in an alkali aqueous solution, and the resin composition suffers unavoidably discoloration under thermal history since the modified oxetane resin and the polyfunctional oxetane resin have an unsaturated bond. Patent Documents 6 to 10 disclose a cage-type silicon compound and a polymer thereof, but fail to disclose the thermosetting resin composition of the invention.

Patent Document 1: JP-A-S61-112334

Patent Document 2: JP-A-H02-289611

Patent Document 3: JP-A-2003-277473

Patent Document 4: JP-A-2004-27186

Patent Document 5: WO 01/072857A

Patent Document 6: JP-A-2006-070049

Patent Document 7: WO 2004/081084A

Patent Document 8: JP-A-2004-331647

Patent Document 9: WO 2003/24870A

Patent Document 10: WO 2004/24741A

### SUMMARY OF THE INVENTION

An object of the invention is to provide a thermosetting resin composition capable of providing a cured product having favorable heat resistance and transparency. Another object of the invention is to provide a cured product and a molded article containing the resin composition.

As a result of earnest investigations made by the inventors for solving the problems, a thermosetting resin composition that is excellent, for example, in insulating property, transparency, light stability and heat resistance has been developed, and thus the invention has been completed.

The invention includes the following aspects.

1. A thermosetting resin composition containing a silsesquioxane derivative represented by the formula (1), cyclohexane-1,3,4-tricarboxylic-3,4-anhydride, and another acid anhydride:

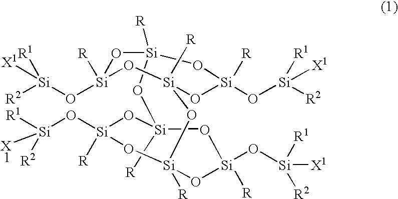

wherein R represents a group selected independently from alkyl having from 1 to 45 carbon atoms, cycloalkyl having from 4 to 8 carbon atoms, aryl having from 6 to 14 carbon atoms and an arylalkyl having from 7 to 24 carbon atoms; in the alkyl having from 1 to 45 carbon atoms, arbitrary hydrogen may be replaced by fluorine, and arbitrary —CH₂— may be replaced by —O— or —CH═CH—, provided that plural —CH₂— adjacent to each other are not replaced simultaneously; in the benzene ring of the aryl and the arylalkyl, arbitrary hydrogen may be replaced by halogen or alkyl having from 1 to 10 carbon atoms; in the alkyl having from 1 to 10 carbon atoms, arbitrary hydrogen may be replaced by fluorine, and arbitrary —CH₂— may be replaced by —O— or —CH═CH—, provided that plural —CH₂— adjacent to each other are not replaced simultaneously; the alkylene in the arylalkyl has from 1 to 10 carbon atoms, in which arbitrary —CH₂— may be replaced by —O—, provided that plural —CH₂— adjacent to each other are not replaced simultaneously; R¹ and R² each represent a group selected independently from alkyl having from 1 to 4 carbon atoms, cyclopentyl, cyclohexyl and phenyl; X⁻ represents a group having one of oxiranyl, oxyranylene, 3,4-epoxycyclohexyl, oxetanyl and oxetanylene.

2. The thermosetting resin composition according to the item 1, wherein R represents cyclohexyl or phenyl.

3. The thermosetting resin composition according to the item 1, wherein R represents phenyl.

4. The thermosetting resin composition according to one of the items 1 to 3, wherein X¹ represents a group represented by one of the formulae (2), (3), (4) and (5):

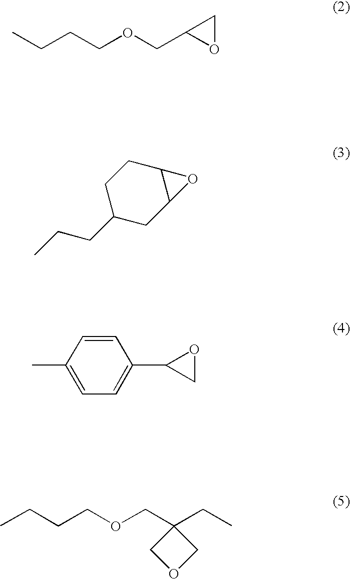

5. A thermosetting resin composition containing a silsesquioxane derivative represented by the formula (1-1), cyclohexane-1,3,4-tricarboxylic-3,4-anhydride, and another acid anhydride:

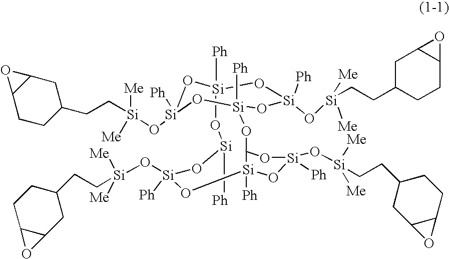

6. The thermosetting resin composition according to one of the items 1 to 5, wherein the another acid anhydride is at least one selected from phthalic anhydride, maleic anhydride, trimellitic anhydride, pyromellitic anhydride, hexahydrophthalic anhydride, 3-methylcyclohexanedicarboxylic anhydride, 4-methylcyclohexanedicarboxylic anhydride, a mixture of 3-methylcyclohexanedicarboxylic anhydride and 4-methylcyclohexanedicarboxylic anhydride, tetrahydrophthalic anhydride, nadic anhydride, methylnadic anhydride, norbornene-2,3-dicarboxylic anhydride and methylnorbornene-2,3-dicarboxylic anhydride.

7. The thermosetting resin composition according to one of the items 1 to 6, wherein the composition further contains an epoxy resin containing no silicon atom in the molecule thereof, an oxetane resin containing no silicon atom in the molecule thereof or an organic solvent.

8. The thermosetting resin composition according to one of the items 1 to 7, wherein the composition further contains an ultraviolet absorber, a curing accelerator or an antioxidant.

9. A cured product containing the thermosetting resin composition according to one of the items 1 to 8 having been thermally cured.

10. A molded article containing the cured product according to the item 9.

A cured product of the thermosetting resin composition of the invention is excellent, for example, in insulating property, transparency, light stability and heat resistance. Accordingly, a molded article containing the cured product can be favorably applied to such purposes as a sealing material for a semiconductor device, a sealing material for an optical semiconductor device, an insulating film, a sealing agent and an optical lens. The thermosetting resin composition of the invention can be used, for example, as an adhesive owing to the thermal curing property thereof.

### DETAILED DESCRIPTION OF THE INVENTION

The terms used herein will be described. A compound represented by the formula (1) may be referred to as a compound (1). Compounds represented by the other formulae may also be abbreviated in the same manner. The term “arbitrary” referred herein means that not only the position but also the number are arbitrarily selected. The expression “arbitrary A may be replaced by B or C” includes the case where at least one A is replaced by B and the case where at least one A is replaced by C, and also includes the case where at least one A is replaced by B, and simultaneously another A is replaced by C. The definition “arbitrary —CH₂— in alkyl or alkylene may be replaced by —O—” excludes the case where plural —CH₂— adjacent to each other are all replaced by —O—. In the examples, the data obtained with an electronic balance are expressed in terms of g (gram) as a mass unit. The percentages by weight and the weight ratios in the examples are based on the data.

The thermosetting resin composition of the invention contains a silsesquioxane derivative represented by the formula (1) as an essential component. In the following description, the shape of the silsesquioxane skeleton of the formula (1) may be referred to as a double-decker structure.

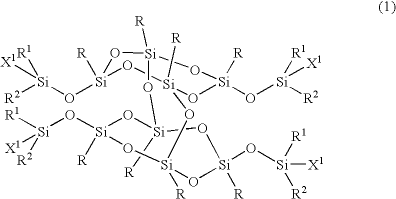

In the formula (1), R represents a group selected independently from alkyl having from 1 to 45 carbon atoms, cycloalkyl having from 4 to 8 carbon atoms, aryl having from 6 to 14 carbon atoms and an arylalkyl having from 7 to 24 carbon atoms. In the alkyl having from 1 to 45 carbon atoms, arbitrary hydrogen may be replaced by fluorine, and arbitrary —CH₂— may be replaced by —O— or —CH═CH—, provided that plural —CH₂— adjacent to each other are not replaced simultaneously. In the benzene ring of the aryl and the arylalkyl, arbitrary hydrogen may be replaced by halogen or alkyl having from 1 to 10 carbon atoms. In the alkyl having from 1 to 10 carbon atoms, arbitrary hydrogen may be replaced by fluorine, and arbitrary —CH₂— may be replaced by —O— or —CH═CH—, provided that plural —CH₂— adjacent to each other are not replaced simultaneously. The alkylene in the arylalkyl has from 1 to 10 carbon atoms, in which arbitrary —CH₂— may be replaced by —O—, provided that plural —CH₂— adjacent to each other are not replaced simultaneously.

R preferably represents a group selected independently from cyclopentyl, cyclohexyl, phenyl and alkyl having from 1 to 10 carbon atoms. In the alkyl having from 1 to 10, arbitrary hydrogen may be replaced by fluorine, and arbitrary —CH₂— may be replaced by —O—, provided that plural —CH₂— adjacent to each other are not replaced simultaneously. Also, in the phenyl, arbitrary hydrogen may be replaced by halogen such as fluorine or alkyl having from 1 to 10 carbon atoms.

R more preferably represents cyclopentyl, cyclohexyl, or phenyl, in which arbitrary hydrogen may be replaced by chlorine, fluorine, methyl, methoxy or trifluoromethyl, R further preferably represents cyclohexyl or phenyl, and R most preferably represents phenyl.

In the formula (1), R¹ and R² each represent a group selected independently from alkyl having from 1 to 4 carbon atoms, cyclopentyl, cyclohexyl and phenyl. Examples of the alkyl having from 1 to 4 carbon atoms include methyl, ethyl, propyl, 2-methylethyl, butyl and t-butyl. Preferred examples of R¹ and R² include methyl and phenyl. R¹ and R² preferably represent the same groups.

In the formula (1), X¹ represents a group having one of oxiranyl, oxyranylene, 3,4-epoxycyclohexyl, oxetanyl and oxetanylene.

Preferred examples of X¹ include groups represented by the following formulae.

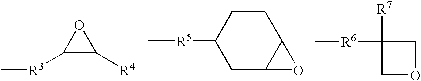

In the formulae, R³, R⁵ and R⁶ each represent alkylene having from 1 to 10 carbon atoms, and preferably alkylene having from 1 to 6 carbon atoms. In the alkylene, one —CH₂— may be replaced by —O— or 1,4-phenylene. R⁴ represents hydrogen or alkyl having from 1 to 6 carbon atoms, and preferably hydrogen. R⁷ represents hydrogen or alkyl having from 1 to 6 carbon atoms, and preferably alkyl having from 1 to 6 carbon atoms.

Particularly preferred examples of X¹ include groups represented by the formulae (2), (3), (4) and (5).

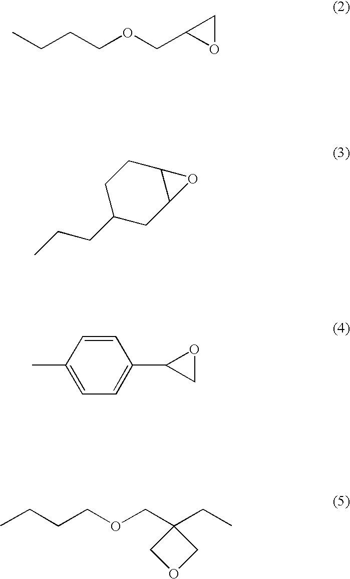

In the invention, an epoxy resin containing no silicon atom in the molecule thereof, and an oxetane resin containing no silicon atom in the molecule thereof may be used in addition to the compound (1). Specific examples of the epoxy resin include epoxy resins of a bisphenol A type, a bisphenol F type, a bisphenol S type, a hydrogenated bisphenol A type, and alicyclic epoxy resins, such as Celloxide (a trade name) 2021 P, Celloxide (a trade name) 3000 and Celloxide (a trade name) 2081, all produced by Daicel Chemical Industries, Ltd. Specific examples of the oxetane resin include oxetane resins, such as Aron Oxetane (trademark), produced by Toagosei Co., Ltd. An alicyclic epoxy resin is particularly preferred since it is excellent in improvement in heat resistance and resistance to yellowing under heat.

In the case where the oxetane resin or the alicyclic epoxy resin containing no silicon atom in the molecule thereof is used, the mixing ratio thereof is preferably from 5 to 95% by weight, and more preferably from 25 to 75% by weight, based on the total amount of the thermosetting resin composition.

In the invention, the compound (1), cyclohexane-1,3,4-tricarboxylic-3,4-anhydride (H-TMAn, produced by Mitsubishi Gas Chemical Co., Inc.) as an acid anhydride, and another acid anhydride can be reacted without a curing accelerator, but a curing accelerator may be used.

Examples of the another acid anhydride include phthalic anhydride, maleic anhydride, trimellitic anhydride, pyromellitic anhydride, hexahydrophthalic anhydride, 3-methylcyclohexanedicarboxylic anhydride, 4-methylcyclohexanedicarboxylic anhydride, a mixture of 3-methylcyclohexanedicarboxylic anhydride and 4-methylcyclohexanedicarboxylic anhydride, tetrahydrophthalic anhydride, nadic anhydride, methylnadic anhydride, norbornene-2,3-dicarboxylic anhydride and methylnorbornene-2,3-dicarboxylic anhydride.

The ratio of the acid anhydride used in the thermosetting resin composition is preferably from 3/7 to 7/3, more preferably from 4/6 to 6/4, and further preferably 1/1, in terms of a molar ratio of the epoxy group and the acid anhydride in the thermosetting resin composition.

The molar ratio of cyclohexane-1,3,4-tricarboxylic 3,4-anhydride (which may be abbreviated as H-TMAn) and the another acid anhydride in the thermosetting resin composition may be from 1/100 to 100/1, preferably from 1/5 to 5/1, and particularly preferably from 1/2 to 2/1. In the case where Rikacid (a trade name) MH-700G, produced by New Japan Chemical Co., Ltd. is used as the acid anhydride, it is preferably used with H-TMAn at a ratio H-TMAn/MH-700G of 1/2 from the standpoint of heat resistance and yellowing resistance.

Examples of the curing accelerator include a quaternary phosphonium salt, such as tetraphenylphosphonium bromide, tetrabutylphosphonium bromide, methyltriphenylphosphonium bromide, ethyltriphenylphosphonium bromide and n-butyltriphenylphosphonium bromide; a tertiary amine; a quaternary ammonium salt; a bicyclic amidine compound or a derivative thereof, such as 1,8-diazabicyclo[5,4,0]undecene-7; and an imidazole compound, such as 2-methylimidazole and 2-phenyl-4-methylimidazole, but the curing accelerator is not particularly limited as far as favorable curing property is obtained, and no coloration occurs. The curing accelerator may be used solely or in combination of two or more kinds thereof. The bicyclic amidine compound, such as 1,8-diazabicyclo[5,4,0]undecene-7, and the imidazole compound are preferred since they exhibit high activity with a small addition amount to the thermosetting resin composition, thereby curing the composition in a short period of time at a relatively low temperature, for example, in about 90 seconds at about 150° C. Preferred examples of the commercially available products thereof include Nikka Octhix Zinc (a trade name), produced by Nihon Kagaku Sangyo Co., Ltd., and U-CAT 5003 (a trade name), produced by San-Apro Ltd.

In the case where the curing accelerator is used, the ratio thereof used is preferably from 0.003 to 0.04, and more preferably from 0.004 to 0.02, in terms of a weight ratio based on the total amount of the thermosetting resin composition. The use of the curing accelerator in an amount within the range provides sufficient curing acceleration effect without deterioration in property and coloration of the cured product.

The thermosetting resin composition of the invention may contain an antioxidant. The addition of the antioxidant prevents deterioration due to oxidation under heat to provide a cured material suffering less coloration. Examples of the antioxidant include antioxidants of a phenol type, a sulfur type and a phosphorus type. The mixing ratio of the antioxidant used is preferably from 0.0001 to 0.1 in terms of a weight ratio based on the total amount of the thermosetting resin composition.

Specific examples of the antioxidant include a monophenol compound (such as 2,6-di-t-butyl-p-cresol, butylated hydroxyanisol, 2,6-di-t-butyl-p-ethylphenol and stearyl-p-(3,5-di-t-butyl-4-hydroxyphenyl) propionate), a bisphenol compound (such as 2,2′-methylenebis(4-methyl-6-t-butylphenol), 2,2′-methylenebis(4-ethyl-6-t-butylphenol), 4,4′-thiobis(3-methyl-6-t-butylphenol), 4,4′-butylidenebis(3-methyl-6-t-butylphenol) and 3,9-bis(1,1-dimethyl-2-(β-(3-t-butyl-4-hydroxy-5-methylphenyl)propionyloxy)ethyl)-2,4,8,10-tetraoxaspiro[5,5]undecane), a polymer type phenol compound (such as 1,1,3-tris(2-methyl-4-hydroxy-5-t-butylphenyl)butane, 1,3,5-trimethyl-2,4,6-tris(3,5-di-t-butyl-4-hydroxybenzyl)benzene, tetrakis(methylene-3-(3′,5′-di-t-butyl-4′-hydroxyphenyl) propionate)methane, bis(3,3′-bis(4′-hydroxy-3′-t-butylphenyl)butyric acid) glycol ester, 1,3,5-tris(3′,5′-di-t-butyl-4′-hydroxybenzyl)-S-triazine-2,4,6-(1H,3H,5H)trione and tocopherol), a sulfur antioxidant (such as dilauryl-3,3′-thiodipropionate, dimyristyl-3,3′-thiodipropionate and distearyl-3,3′-thiodipropionate), a phosphite compound (such as diphenyl phosphite, diphenyl isodecyl phosphite, phenyl isodecyl phosphite, tris(nonylphenyl)phosphite, diisodecyl pentaerythritol phosphite, tris(2,4-di-t-butylphenyl)phsophite, cyclic neopentanetetraylbis(octadecyl)phosphite, cyclic neopentanetetraylbis(2,4-di-t-butylphenyl)phosphite, cyclic neopentanetetraylbis (2, 4-di-t-butyl-4-methylphenyl)phosphite and bis(2-t-butyl-6-methyl-4-(2-(octadecyloxycarbonyl)ethyl)-phenyl)hydrogenphosphite), and an oxaphosphaphenanthrene oxide compound (such as 9,10-dihydro-9-oxa-10-phosphaphenanthrene-10-oxide, 10-(3,5-di-t-butyl-4-hydroxybenzyl)-9,10-dihydro-9-oxa-10-phsophaphenanthrene-10-oxide and 10-decyloxy-9,10-dihydro-9-oxa-10-phosphaphenanthrene-10-oxide). These antioxidants may be used solely, and in particular, a phenol antioxidant and a sulfur antioxidant, or a phenol antioxidant and a phosphorus antioxidant are preferably used in combination. Examples of the commercially available phenol antioxidant include Irganox 1010 (a trade name) and Irgafos 168 (a trade name), produced by Ciba Japan K.K., which may be used solely or as a mixture thereof.

The thermosetting resin composition of the invention may contain an ultraviolet absorber for enhancing the light stability. Examples of the ultraviolet absorber include ordinary ultraviolet absorber for plastics, and the mixing ratio thereof is preferably from 0.0001 to 0.1 in terms of a weight ratio based on the total amount of the thermosetting resin composition.

Specific examples of the ultraviolet absorber include a salicylic acid compound, such as phenyl salicylate, p-t-butylphenyl salicylate and p-octylphenyl salicylate, a benzophenone compound, such as 2,4-dihydroxybenzophenone, 2-hydroxy-4-methoxybenzophenone, 2-hydroxy-4-octoxybenzophenone, 2-hydroxy-4-dodecyloxybenzophenone, 2,2′-dihydroxy-4-methoxybenzophenone, 2,2′-dihydroxy-4,4′-dimethoxybenzophenone and 2-hydroxy-4-methoxy-5-sulfobenzophenone, a benzotriazole compound, such as 2-(2′-hydroxy-5′-methylphenyl)benzotriazole, 2-(2′-hydroxy-5′-t-butylphenyl)benzotriazole, 2-(2′-hydroxy-3′,5′-di-t-butylphenyl)benzotriazole, 2-(2′-hydroxy-3′-t-butyl-5′-methylphenyl)-5-chlorobenzotriazole, 2-(2′-hydroxy-3′,5′-di-t-butylphenyl)-5-chlorobenzotriazole, 2-(2′-hydroxy-3′,5′-di-t-amylphenyl)benzotriazole and 2-((2′-hydroxy-3′,3″,4″,5″,6″-tetrahydrophthalimidemethyl)-5′-methyphenyl)benzotriazole, and a hindered amine compound, such as bis(2,2,6,6-tetramethyl-4-piperidyl)sebacate, bis(1,2,2,6,6-pentamethyl-4-piperidyl)sebacate and bis(1,2,2,6,6-pentamethyl-4-piperidyl)-((3,5-bis(1,1-diemthylethyl)-4-hydroxyphenyl)methyl)butyl malonate.

The thermosetting resin composition of the invention may further contain the following components.

(1) A reinforcing agent and a filler in the form of powder may be contained, examples of which include a metallic oxide, such as aluminum oxide and magnesium oxide, a silicon compound, such as fine powder silica, fused silica and crystalline silica, a transparent filler, such as glass beads, a metallic hydroxide, such as aluminum hydroxide, and other materials, such as kaolin, mica, quartz powder, graphite and molybdenum disulfide. These materials may be added in an amount within such a range that the thermosetting resin composition is not deteriorated in transparency. The mixing ratio thereof is preferably from 0.10 to 1.0 in terms of a weight ratio based on the total amount of the thermosetting resin composition.

(2) A colorant and a pigment may be contained, examples of which include titanium dioxide, molybdenum red, iron blue, ultramarine blue, cadmium yellow, cadmium red and an organic colorant.

(3) A flame retardant may be contained, examples of which include antimony trioxide, a bromine compound and a phosphorus compound.

(4) An ion absorbent may be contained. The mixing ratio thereof is preferably from 0.0001 to 0.30 in terms of a weight ratio based on the total amount of the thermosetting resin composition.

(5) A silane coupling agent may be contained.

(6) A dispersion of metallic oxide nanoparticles, such as zirconia, titania, alumina and silica, may be contained.

The mixing ratio of the components (1) to (6) is preferably from 0.01 to 0.50 in terms of a weight ratio based on the total amount of the thermosetting resin composition.

The cured material can be produced, for example, by the following manner. The silsesquioxane derivative represented by the formula (1) or (1-1), cyclohexane-1,3,4-tricarboxylic 3,4-anhydride and the another acid anhydride are mixed. An antioxidant is added to the resulting mixture under stirring, followed by deaerated under reduced pressure. The mixture is cast in a mold and cured by heating to 100° C. for 1 hour, then to 125° C. for 1 hour, and finally to 150° C. for 2 to 3 hours.

The thermosetting resin composition of the invention may contain an additive, such as a curing accelerator, an antioxidant and an ultraviolet absorber.

The transparency of the cured product is evaluated the yellowness index (YI) calculated according to JIS K7363 and the holding ratio of light transmittance obtained by measuring the transmittance of he cured product before and after a heat resistance test with an ultraviolet and visible spectrophotometer, which are preferably about 10 and 70% or more, respectively. The values within the ranges show that the cured product is colorless and has high transparency, and thus can be particularly preferably applied to such a purpose that requires transparency, such as a sealing material for an optical semiconductor device.

The cured product obtained by thermally curing the thermosetting resin composition of the invention may be molded to form a molded article, which may be applied to various purposes. Examples of the purposes include a sealing material for an optical semiconductor device, a sealing material for a semiconductor device, an insulating film, a sealing agent, an adhesive and an optical lens.

### EXAMPLE

The invention will be described in more detail with reference to the following examples, but the invention is not limited to the examples.

### Synthesis Example 1

### Production of Compound (1-1)

The compound (1-1) was produced by the following route.

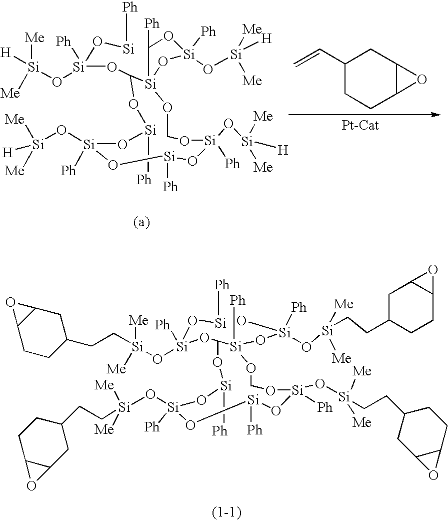

The compound (a), which was synthesized according to the method disclosed in WO 2004/024741, (21.0 g) and dry toluene (20 g) were charged under a nitrogen atmosphere into a reaction vessel having a capacity of 200 mL equipped with a thermometer, a dropping funnel and a reflux condenser, and the reaction vessel was sealed with dry nitrogen. The mixture was heated to a reaction temperature of 60° C. under stirring with a magnetic stirrer. A Pt catalyst (21 μL) was added with a microsyringe, and Celloxide (a trade name) 2000 (product name: CEL2000), produced by Daicel Chemical Industries, Ltd., (10 g) was slowly added dropwise from a dropping funnel, followed by stirring for 3 hours. The content of the reaction vessel was placed in an evaporator and concentrated to provide crude crystals. Acetone was added to the resulting crude crystals to provide a 20% by weight solution. Activated carbon in an amount of 3% by weight of the crude crystals was added to the solution, followed by stirring for 1 hour. Thereafter, the activated carbon was filtered off, and hexane in an amount of 10 times the crude crystals was added to the solution, followed by stirring at 25° C. for 2 hours. The solution was then filtered, and the filtrate was concentrated with an evaporator. Hexane in an amount of 1.25 times the resulting crude crystals was added thereto, followed by heating to 60° C. for dissolving the crystals, and the crystals were recrystallized at 25° C. NMR measurement of the resulting crystals (yield: 22 g, 76%) revealed that the compound (1-1) was obtained.

¹H-NMR (CDCl₃): δ (ppm); 0.01 (s, 24H), 0.40-0.46 (m, 8H), 0.58-0.63 (m, 2H), 0.83-0.87 (m, 4H), 0.95-1.26 (m, 18H), 1.45-1.49 (m, 2H), 1.59-1.81 (m, 6H), 1.98 (dd, 4H), 2.91-3.03 (m, 8H), 7.14 (t, 8H), 7.25 (t, 8H), 7.33 (t, 4H), 7.38-7.43 (m, 12H), 7.45 (d, 8H)

²⁹Si-NMR (CDCl₃): δ (ppm); −106.92, −79.41, −79.18, 11.26, 11.28, 11.34, 11.36

### Major Component Materials Used in Examples

Silsesquioxane derivative: Compound (1-1) produced in Synthesis Example
Cyclohexane-1,3,4-tricarboxylic-3,4-anhydride: Acid Anhydride H-TMAn, produced by Mitsubishi Gas Chemical Co., Inc.
Hexahydrophthalic anhydride: Rikacid (a trade name) MH-700G, produced by New Japan Chemical Co., Ltd.
Epoxy resin: Celloxide (a trade name) 2021 P (product name: CEL2021P), produced by Daicel Chemical Industries, Ltd.
Antioxidant: Irganox 1010 (a trade name), produced by Ciba Japan K.K.
Curing accelerator: U-CAT 5003 (a trade name), produced by San-Apro Ltd.

### Example 1

H-TMAn (0.91 g) and MH-700G (2.0 g) were charged in a screw tube 1 and dissolved by stirring. MH-700G (0.75 g), CEL2021P (2.0 g) and the compound (1-1) (4.0 g) were charged in a screw tube 2 and dissolved by heating to 45° C. under stirring. After dissolving, Irganox 1010 (a trade name) (10 mg) was added and dissolved by stirring.

The solution in the screw tube 2 was poured into the screw tube 1, and the content was sufficiently stirred to prepare a varnish. The varnish was deaerated under reduced pressure while stirring in a desiccator, and an about 7 g portion thereof was cast in a petri dish formed of Teflon (trademark) PFA, produced by Flon Industry Co., Ltd., while preventing bubbles from being entrained. The petri dish was placed in an oven, which had been heated to 100° C. in advance, while preventing the petri dish from being exposed directly to hot air stream, thereby curing the varnish under heat. The heating operation was effected at 100° C. for 1 hour, 125° C. for 1 hour and 150° C. for 3 hours in this order.

### Example 2

H-TMAn (0.27 g) and MH-700G (2.0 g) were charged in a screw tube 3 and dissolved by stirring. MH-700G (1.75 g), CEL2021P (2.0 g) and the compound (1-1) (4.0 g) were charged in a screw tube 4 and dissolved by heating to 45° C. under stirring. After dissolving, Irganox 1010 (a trade name) (10 mg) was added and dissolved by stirring.

The solution in the screw tube 4 was poured into the screw tube 3, and the content was sufficiently stirred to prepare a varnish. The varnish was deaerated under reduced pressure while stirring in a desiccator, and an about 7 g portion thereof was cast in a petri dish formed of Teflon (trademark) PFA, produced by Flon Industry Co., Ltd., while preventing bubbles from being entrained. The petri dish was placed in an oven, which had been heated to 100° C. in advance, while preventing the petri dish from being exposed directly to hot air stream, thereby curing the varnish under heat. The heating operation was effected at 100° C. for 1 hour, 125° C. for 1 hour and 150° C. for 3 hours in this order.

### Comparative Example 1

MH-700G (4.17 g), CEL2021P (2.0 g) and the compound (1-1) (4.0 g) were charged in a screw tube 5 and dissolved by heating to 45° C. under stirring. After dissolving, Irganox 1010 (a trade name) (10 mg) was added and dissolved by stirring. Nikka Octhix Zinc (a trade name) 8% (12 mg) was added thereto and dissolved by stirring. Ethylene glycol (40 mg) was added thereto and dissolved by stirring to prepare a varnish. The varnish was deaerated under reduced pressure while stirring in a desiccator, and an about 7 g portion thereof was cast in a petri dish formed of Teflon (trademark) PFA, produced by Flon Industry Co., Ltd., while preventing bubbles from being entrained. The petri dish was placed in an oven, which had been heated to 100° C. in advance, while preventing the petri dish from being exposed directly to hot air stream, thereby curing the varnish under heat. The heating operation was effected at 100° C. for 1 hour, 125° C. for 1 hour and 150° C. for 3 hours in this order.

### Comparative Example 2

U-CAT 5003 (12 mg) and MH-700G (3.0 g) were charged in a screw tube 6 and dissolved by stirring. MH-700G g), CEL2021P (2.0 g) and the compound (1-1) (4.0 g) were charged in a screw tube 7 and dissolved by heating to 45° C. under stirring. After dissolving, Irganox 1010 (a trade name) (10 mg) was added and dissolved by stirring.

The solution in the screw tube 6 was poured into the screw tube 7, and the content was sufficiently stirred to prepare a varnish. The varnish was deaerated under reduced pressure while stirring in a desiccator, and an about 7 g portion thereof was cast in a petri dish formed of Teflon (trademark) PFA, produced by Flon Industry Co., Ltd., while preventing bubbles from being entrained. The petri dish was placed in an oven, which had been heated to 100° C. in advance, while preventing the petri dish from being exposed directly to hot air stream, thereby curing the varnish under heat. The heating operation was effected at 100° C. for 1 hour, 125° C. for 1 hour and 150° C. for 3 hours in this order.

### Heat Resistance Test

The cured products obtained in Examples 1 and 2 and Comparative Examples 1 and 2 each were polished on both surfaces thereof with a polishing machine (MA-200D, produced by Musashino Densi Co., Ltd.) to provide test pieces having a thickness of 3 mm with flat polished surfaces for measuring transmittance at 400 mm.

The resulting cured product was cut into two pieces, and one was not subjected to a heat treatment, whereas the other was placed in an oven (blower thermostat dryer, DRM420DA, produced by Advantec Toyo Co., Ltd.) having an internal temperature adjusted to 150° C. for 168 hours.

### Evaluation of Heat Resistance

The heat resistance of the cured product was evaluated by measuring the cured product before and after the heat resistance test for light transmittance with an ultraviolet and visible spectrophotometer (V-660, produced by JASCO Corporation) and calculating the yellowness index (YI) and the holding ratio of the transmittance at a wavelength of 400 nm according to the expression (I).

(transmittance after heat resistance test)/(initial transmittance)×100 (I)

### Test Results

The results of the test are shown in Table 1.

TABLE 1

| | | | Initial | Transmittance | Holding ratio |
|---|---|---|---|---|---|
| | | YI after 168 | transmittance | after 168 hours | after 168 hours |
| | Initial YI | hours | (% T) at 400 nm | (% T) at 400 nm | (%) |
| Example 1 | 1.4 | 9.1 | 87 | 69 | 80 |
| Example 2 | 1.4 | 10 | 88 | 67 | 76 |
| Comparative Example 1 | 1.2 | 13 | 86 | 58 | 68 |
| Comparative Example 2 | 2.0 | 24 | 84 | 35 | 42 |

### Example 3

H-TMAn (8.57 g) and MH-700G (25.98 g) were charged in a screw tube 8 and dissolved by stirring. After dissolving, Irganox 1010 (a trade name) (70.6 mg) was added and dissolved by stirring. CEL2021P (27.0 g) and the compound (1-1) (9.0 g) were charged in a screw tube 9 and dissolved by heating to 45° C. under stirring. The solution in the screw tube 9 was poured into the screw tube 8, and the content was sufficiently stirred to prepare a varnish. The varnish was deaerated under reduced pressure while stirring in a desiccator.

### Production of Cured Product

A mold for thermally curing the varnish to provide a cured product was fabricated in the following manner. Two sheets of stainless steel plates (hereinafter referred to as SUS plates) having a square shape with about 200 mm on one edge having attached to one surface thereof a fluorine resin sheet (Teflon (trademark) FEP adhesive sheet, produced by Flon Industry Co., Ltd.) were prepared. A fluorine resin gasket (Nafion (trademark) SP Packing 5.6 mm in diameter, produced by Nichias Corporation) was placed on three edges of one of the SUS plates, and the gasket was held with the other SUS plate with the fluorine resin sheets facing each other. The two SUS plates were fixed to fabricate a mold. The space surrounded with the fluorine resin gasket had an edge of about 100 mm and a thickness of from 4.2 to 4.5 mm. The varnish was poured in to the mold from the edge having no gasket held. The mold having the varnish cast therein was placed in an oven, which had been heated to 125° C. in advance, and cured by heating to 125° C. for 1 hour and 150° C. for 3 hours to provide a cured product (having a size of about 100×100 mm and a thickness of from 4.2 to 4.5 mm). The resulting cured product was cut with a band saw and polished with a multiprep sample polisher (Item No. 15-2000, produced by Allied High Tech Products, Inc.).

### Examples 4 to 8 and Comparative Example 3

A varnish was prepared, and a cured product was produced therewith, in the same manner as in Example 3 except that H-TMAn, MH-700G, CEL2021P and the compound (1-1) were charged at the ratios shown in Table 2. The test pieces obtained were evaluated in the manner described later. Table 2 shows the composition of the cured products. Table 3 shows the evaluation results of the test pieces obtained in Examples 3 to 8 and Comparative Example 3.

TABLE 2

| | | | | | | | Comparative |
|---|---|---|---|---|---|---|---|
| | Example 3 | Example 4 | Example 5 | Example 6 | Example 7 | Example 8 | Example 3 |
| Compound (1-1) (g) | 9.0 | 19.0 | 19.0 | 28.0 | 33.0 | 50.0 | — |
| CEL2021P (g) | 27.0 | 38.0 | 19.0 | 14.0 | 11.0 | — | 30.0 |
| H-TMAn (g) | 8.57 | 12.58 | 7.06 | 6.34 | 5.88 | 4.07 | 8.71 |
| MH-700G (g) | 25.98 | 38.13 | 21.41 | 19.2 | 17.82 | 12.34 | 26.4 |
| Irganox 1010 (g) | 0.0706 | 0.1077 | 0.0665 | 0.0676 | 0.0677 | 0.0664 | 0.0651 |

### Total Light Transmittance and Turbidimetric Measurement

The cured product was polished on both surfaces thereof to a thickness of 3 mm to provide a test piece, which was measured for total light transmittance, diffuse transmittance and turbidity with a haze meter (NHD 5000, produced by Nippon Denshoku Industries Co., Ltd.).

### Refractive Index

The cured product was cut with a band saw, and a test piece was produced according to JIS K7142. The test piece was measured for refractive index with an Abbe refractometer (NAR-2T, produced by Atago Co., Ltd.) using the D line (586 nm) of a sodium lamp. Methylene iodide was used as a contact liquid.

### Flexural Strength Test

A test piece was produced from the cured product according to JIS K7171. The test piece was measured for flexural elastic modulus and flexural breaking strength with a tensile and compressional tester (Strograph V10-C, produced by Toyo Seiki Seisaku-sho, Ltd.) using a 5 kN load cell.

### Shore Hardness

A test piece was produced from the cured product according to JIS B7727. The test piece was measured for hardness with a shore hardness tester (ASH-D, produced by Mitutoyo Corporation).

### Boiling Test

The cured product was polished on both surfaces thereof to a thickness of 3 mm to provide a test piece, which was boiled in boiling water for 168 hours, and the test piece thus treated was evaluated by visually observing the surface thereof and measuring the holding ratio of the light transmittance at a wavelength of 400 nm with an ultraviolet and visible spectrophotometer.

### Flexural Adhesion Strength Test

A polyphthalamide resin (Amodel (a trade name) A-4122NLWH905, produced by Solvay Advanced Polymers Co., Ltd.) was molded into a plate having a thickness of 2 mm to provide a substrate, and a test piece was produced by adjusting the dimension according to JIS K6856. The test piece was subjected to the adhesion test with a tensile and compressional tester (Strograph V10-C, produced by Toyo Seiki Seisaku-sho, Ltd.) using a 5 kN load cell.

TABLE 3

| | | | | | | | Comparative |
|---|---|---|---|---|---|---|---|
| | Example 3 | Example 4 | Example 5 | Example 6 | Example 7 | Example 8 | Example 3 |
| Total light transmittance (%) | 92.1 | 92.1 | 91.9 | 91.7 | 91.7 | 91.5 | 92.1 |
| Diffuse transmittance (%) | 0.5 | 0.5 | 0.5 | 0.6 | 0.6 | 0.6 | 0.4 |
| Haze | 0.49 | 0.52 | 0.53 | 0.70 | 0.70 | 0.69 | 0.39 |
| Refractive index (n^{d}, 23° C.) | 1.515 | 1.514 | 1.519 | 1.523 | 1.524 | 1.532 | 1.511 |
| Abbe number | 54.4 | 53.7 | 47.5 | 45.5 | 44.6 | 41.6 | 57.2 |
| Flexural elastic modulus (MPa) | 2,540 | 2,400 | 2,380 | 2,220 | 1,780 | 1,700 | 2,900 |
| Flexural breaking strength (MPa) | 90 | 95 | 85 | 72 | 72 | 53 | 90 |
| Shore hardness (HS) | 95 | 94 | 93 | 91 | 91 | 85 | 96 |
| Boiling test (%) | 59 | 71 | 74 | 77 | 83 | 91 | 14 |
| Flexural adhesion strength (MPa) | 0.23 | 0.17 | 0.12 | 0.16 | — | — | 0.19 |

It was understood from Examples and Comparative Examples that the cured product obtained with the thermosetting resin composition of the invention was transparent, had a high refractive index, was excellent in yellowing resistance and boiling water resistance, and can impart flexibility to an epoxy resin without impairing the excellent characteristics in heat resistance. Furthermore, it was understood that the cured product was excellent in insulating property owing to the double-decker type silsesquioxane skeleton thereof.

Accordingly, it was understood that the cured product was able to be applied to a sealing material for a semiconductor device, a sealing material for an optical semiconductor device, an insulating film, a sealing agent, an adhesive and an optical lens.

What is claimed is:

1. A thermosetting resin composition comprising a silsesquioxane derivative represented by the formula (1), cyclohexane-1,3,4-tricarboxylic-3,4-anhydride, and another acid anhydride: 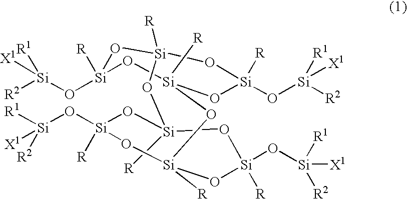
wherein R represents a group selected independently from alkyl having from 1 to 45 carbon atoms, cycloalkyl having from 4 to 8 carbon atoms, aryl having from 6 to 14 carbon atoms and an arylalkyl having from 7 to 24 carbon atoms; in the alkyl having from 1 to 45 carbon atoms, arbitrary hydrogen may be replaced by fluorine, and arbitrary —CH₂— may be replaced by —O— or —CH═CH—, provided that plural —CH₂— adjacent to each other are not replaced simultaneously; in the benzene ring of the aryl and the arylalkyl, arbitrary hydrogen may be replaced by halogen or alkyl having from 1 to 10 carbon atoms; in the alkyl having from 1 to 10 carbon atoms, arbitrary hydrogen may be replaced by fluorine, and arbitrary —CH₂— may be replaced by —O— or —CH═CH—, provided that plural —CH₂— adjacent to each other are not replaced simultaneously; the alkylene in the arylalkyl has from 1 to 10 carbon atoms, in which arbitrary —CH₂— may be replaced by —O—, provided that plural —CH₂— adjacent to each other are not replaced simultaneously; R¹ and R² each represent a group selected independently from alkyl having from 1 to 4 carbon atoms, cyclopentyl, cyclohexyl and phenyl; X¹ represents a group having one of oxiranyl, oxyranylene, 3,4-epoxycyclohexyl, oxetanyl and oxetanylene.

2. The thermosetting resin composition according to claim 1, wherein R represents cyclohexyl or phenyl.

3. The thermosetting resin composition according to claim 1, wherein R represents phenyl.

4. The thermosetting resin composition according to claim 1, wherein X¹ represents a group represented by one of the formulae (2), (3), (4) and (5):

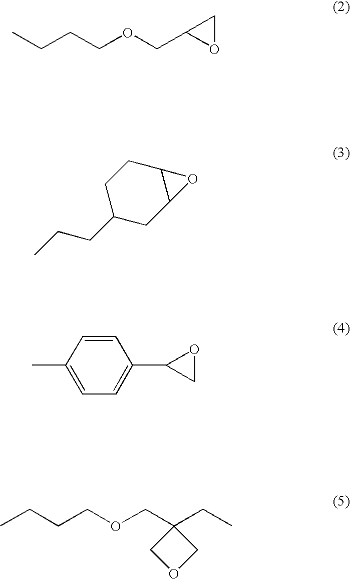

5. The thermosetting resin composition according to claim 1, wherein the another acid anhydride is at least one selected from phthalic anhydride, maleic anhydride, trimellitic anhydride, pyromellitic anhydride, hexahydrophthalic anhydride, 3-methylcyclohexanedicarboxylic anhydride, 4-methylcyclohexanedicarboxylic anhydride, a mixture of 3-methylcyclohexanedicarboxylic anhydride and 4-methylcyclohexanedicarboxylic anhydride, tetrahydrophthalic anhydride, nadic anhydride, methylnadic anhydride, norbornene-2,3-dicarboxylic anhydride and methylnorbornene-2,3-dicarboxylic anhydride.

6. The thermosetting resin composition according to claim 1, wherein the composition further comprises an epoxy resin containing no silicon atom in the molecule thereof, an oxetane resin containing no silicon atom in the molecule thereof or an organic solvent.

7. The thermosetting resin composition according to claim 1, wherein the composition further comprises an ultraviolet absorber, a curing accelerator or an antioxidant.

8. A cured product comprising the thermosetting resin composition according to claim 1 having been thermally cured.

9. A molded article comprising the cured product according to claim 8.

10. A thermosetting resin composition comprising a silsesquioxane derivative represented by the formula (1-1), cyclohexane-1,3,4-tricarboxylic-3,4-anhydride, and another acid anhydride:

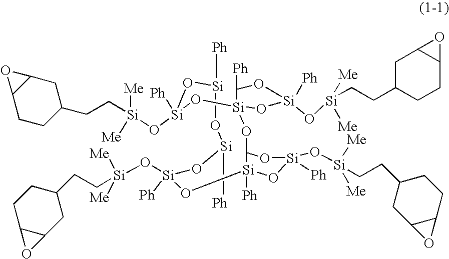

11. The thermosetting resin composition according to claim 10, wherein the another acid anhydride is at least one selected from phthalic anhydride, maleic anhydride, trimellitic anhydride, pyromellitic anhydride, hexahydrophthalic anhydride, 3-methylcyclohexanedicarboxylic anhydride, 4-methylcyclohexanedicarboxylic anhydride, a mixture of 3-methylcyclohexanedicarboxylic anhydride and 4-methylcyclohexanedicarboxylic anhydride, tetrahydrophthalic anhydride, nadic anhydride, methylnadic anhydride, norbornene-2,3-dicarboxylic anhydride and methylnorbornene-2,3-dicarboxylic anhydride.

12. The thermosetting resin composition according to claim 10, wherein the composition further comprises an epoxy resin containing no silicon atom in the molecule thereof, an oxetane resin containing no silicon atom in the molecule thereof or an organic solvent.

13. The thermosetting resin composition according to claim 10, wherein the composition further comprises an ultraviolet absorber, a curing accelerator or an antioxidant.

14. A cured product comprising the thermosetting resin composition according to claim 10 having been thermally cured.

15. A molded article comprising the cured product according to claim 14.
